(19) United States
(12) Patent Application Publication
(10) Pub. No.: US 2019/0320597 A1
(43) Pub. Date: Oct. 24, 2019

(54) Sod Cutter Blade

(71) Applicant: Billy Goat Industries, Inc., Lee's Summit, MO (US)

(72) Inventor: Brandon King, Pleasant Hill, MO (US)

(21) Appl. No.: 16/379,857

(22) Filed: Apr. 10, 2019

Related U.S. Application Data
(60) Provisional application No. 62/660,503, filed on Apr. 20, 2018.

(51) Int. Cl. A01G 20/12

(52) U.S. Cl. CPC A01G 20/12

(57) ABSTRACT

A blade assembly for use with a sod cutter, the blade assembly including a first vertical knife, a second vertical knife, and a horizontal blade extending between and coupled to an interior surface of both the first vertical knife and the second vertical knife. Each of the first vertical knife and the second vertical knife includes a first beveled edge extending along a first frontward-facing edge from a toe portion to a base portion of each of the first vertical knife and the second vertical knife. Additionally, each of the first vertical knife and the second vertical knife also includes a second beveled edge extending along a second frontward-facing edge proximate to a mounting portion of each of the first vertical knife and the second vertical knife.

### CROSS-REFERENCE TO RELATED APPLICATIONS

This application claims the benefit of U.S. Provisional patent application No. 62/660,503, filed Apr. 20, 2018, which is hereby incorporated by reference in its entirety.

### BACKGROUND

The present disclosure relates generally to mechanized sod cutters, and more particularly to a blade configuration for use with a mechanized sod cutter.

Sod cutters have been used for many years, both in large-scale settings (e.g., commercial sod farms), as well as for smaller-scale applications, such as residential sod replacement, landscape redesign, etc. In large-scale operations, a complex, tractor-driven sod cutting system is generally utilized, with the system capable of stacking, palletizing, and/or rolling the harvested sod. However, small-scale sod cutting systems typically rely on a walk-behind, self-propelled sod cutter having an oscillating blade assembly which separates a strip of sod from the soil at a chosen depth. The chosen depth may depend on a variety of factors, such as, e.g., type of grass, condition of the underlying soil, etc.

On walk-behind sod cutters, the oscillating blade assembly typically includes a pair of vertical knives that are removably coupled to respective vertical mounting arms positioned at opposite lateral sides of the sod cutter. An elongated horizontal blade extends between, and is coupled to, each vertical knife. During operation, the vertical mounting arms are driven to oscillate at a high frequency, causing the vertical knives to penetrate and cut the sod at a given width, while the horizontal blade slices below the sod surface at a given depth, thereby creating a removable sod strip. Once a desired strip length is achieved, the operator typically disengages the blade assembly drive and raises the blade assembly out of the soil, thereby severing the sod strip from the adjoining grass and soil and allowing the strip to be rolled, stacked, or otherwise removed. However, the severing of the sod strip at the end of a pass of the sod cutter may be burdensome, particularly when the depth of the blade assembly is selected to provide a relatively thick sod strip and/or when the type of grass being removed is relatively dense and/or contains stolons, as is the case with, e.g., St. Augustine grass.

Accordingly, there is a need for a sod cutter blade configuration capable of improved severing of thick sod strips.

### SUMMARY

In accordance with an aspect of the disclosure, a blade assembly for use with a sod cutter is disclosed. The blade assembly includes a first vertical knife, a second vertical knife, and a horizontal blade extending between and coupled to an interior surface of both the first vertical knife and the second vertical knife. Each of the first vertical knife and the second vertical knife includes a first beveled edge extending along a first frontward-facing edge from a toe portion to a base portion of each of the first vertical knife and the second vertical knife. Additionally, each of the first vertical knife and the second vertical knife includes a second beveled edge extending along a second frontward-facing edge proximate to a mounting portion of each of the first vertical knife and the second vertical knife.

According to another aspect of the disclosure, a sod cutter is disclosed. The sod cutter includes a frame, a power head coupled to the frame, at least one drive wheel operably coupled to the power head, and a gear box coupled to the frame and operably coupled to the power head, wherein the gear box is configured to convey high-frequency oscillatory motion on a first vertical mounting arm on a first lateral side of the frame and a second vertical mounting arm on a second lateral side of the frame opposite the first lateral side. The sod cutter also includes a blade assembly, the blade assembly having a first vertical knife coupled to the first vertical mounting arm, a second vertical knife coupled to the second vertical mounting arm, and a horizontal blade extending between and coupled to an interior surface of both the first vertical knife and the second vertical knife. Each of the first vertical knife and the second vertical knife includes a first beveled edge extending along a first frontward-facing edge from a toe portion to a base portion of each of the first vertical knife and the second vertical knife. Additionally, each of the first vertical knife and the second vertical knife also includes a second beveled edge extending along a second frontward-facing edge proximate to a mounting portion of each of the first vertical knife and the second vertical knife.

In accordance with another aspect of the disclosure, a blade assembly for use with a sod cutter is disclosed. The blade assembly includes a first side and a second side. Each of the first side and the second side includes a forward-most projecting point extending therefrom, a first edge extending rearwardly from forward-most projecting point, and a second edge extending rearwardly from the forward-most projecting point. Furthermore, at least a portion of both the first edge and the second edge of the first side includes a beveled surface.

### BRIEF DESCRIPTION OF THE DRAWINGS

FIG. 1 is a side view of a sod cutter in accordance with an aspect of the disclosure;

FIG. 2 is a perspective view of a sod cutter blade configuration in accordance with an aspect of the disclosure;

FIG. 3 is a side view of the sod cutter blade configuration of FIG. 2; and

FIG. 4 is a perspective view of a sod cutter blade configuration in accordance with another aspect of the disclosure.

### DETAILED DESCRIPTION

The following description is made for the purpose of illustrating the general principles of the present system and method and is not meant to limit the inventive concepts claimed in this document. Further, particular features described in this document can be used in combination with other described features in each of the various possible combinations and permutations.

Unless otherwise specifically defined in this document, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to”. Additionally, use the term “couple”, “coupled”, or “coupled to” may imply that two or more elements may be directly connected or may be indirectly coupled through one or more intervening elements.

In this document, position-identifying terms such as “vertical”, “horizontal”, “front”, “rear”, “side”, “top”, and “bottom” are not intended to limit the invention to a particular direction or orientation, but instead are only intended to denote relative positions, or positions corresponding to directions shown when a sod cutter and/or blade configuration is oriented as shown in the Figures.

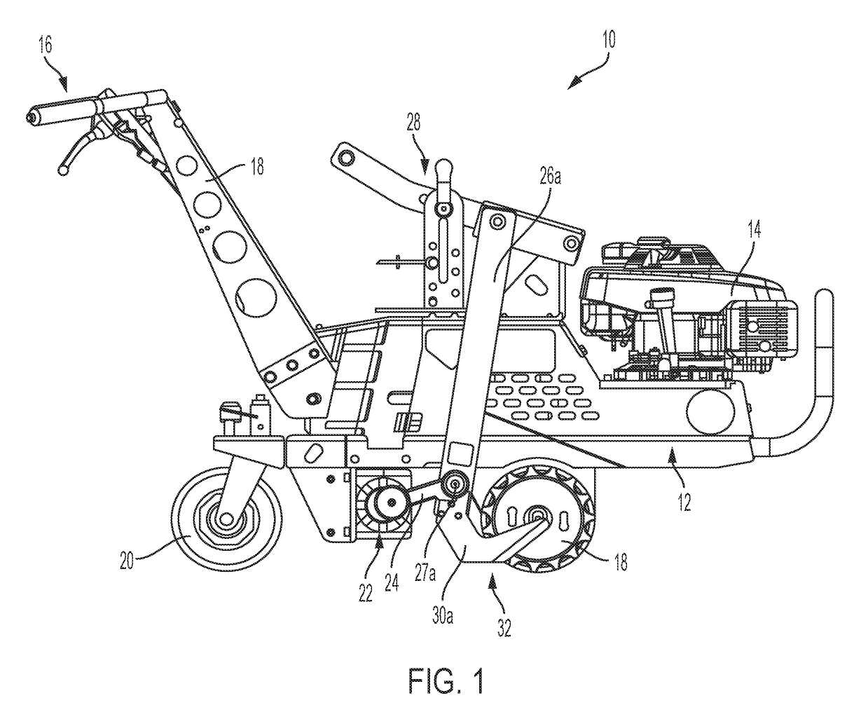

Referring to FIG. 1, a sod cutter 10 in accordance with an aspect of the disclosure is shown. Sod cutter 10 includes a frame 12, with a control extension 18 leading from frame 12 to user handles 16. The user handles 16 are configured to allow an operator to manipulate and control the drive of sod cutter 10, and may include, e.g., throttle controls, blade engagement controls, braking controls, etc. A power head 14 such as, e.g., an internal combustion engine is provided on frame 12 and is configured to drive at least one drive wheel 18, which may be coupled to a transmission (not shown), thereby allowing for the at least one drive wheel to be driven forward and reverse, as well as at varying speeds. A single rear caster wheel 20 may also extend below the frame, allowing the sod cutter 10 to turn freely during operation, while still supporting at least some of the weight of the sod cutter 10. Additionally and/or alternatively, rear caster wheel 20 may be configurable to be locked in a straight position, thereby allowing the sod cutter 10 to maintain travel in a relatively straight path, when desired.

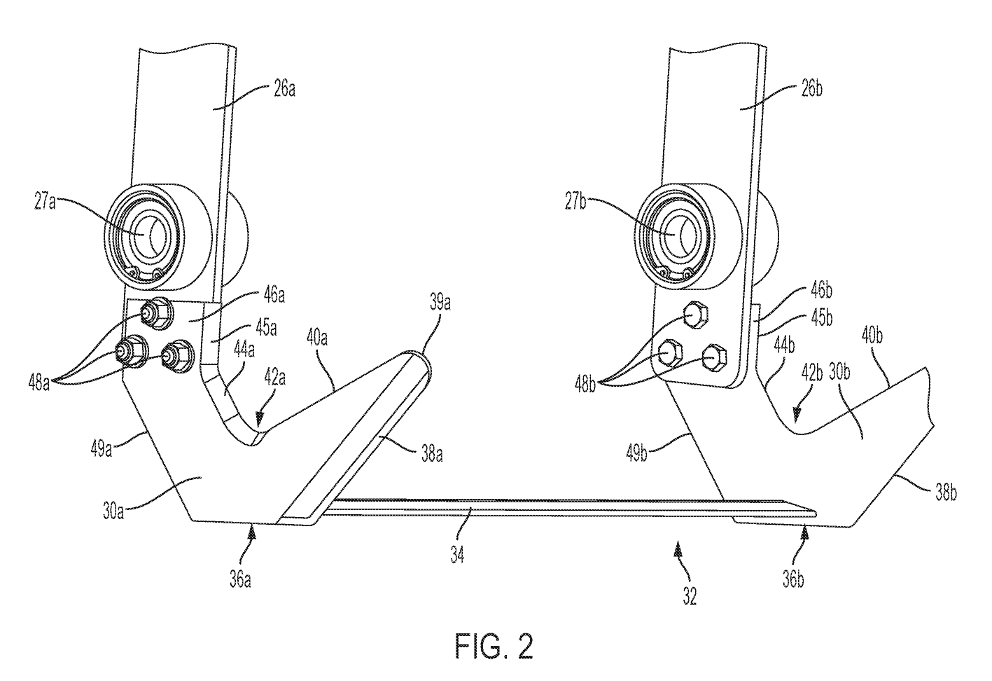

Referring still to FIG. 1 and also to FIG. 2, sod cutter 10 further includes a blade assembly 32, which is removably coupled to both a first vertical mounting arm 26a and a second vertical mounting arm 26b. A proximal end portion of each of the vertical mounting arms 26a, 26b are pivotally coupled to a blade depth adjustment mechanism 28, which enables the operator to set a desired cutting depth, retract the blade assembly 32 from a cutting position, etc. Furthermore, a distal end portion of the vertical mounting arms 26a, 26b are pivotally coupled to a first end of a respective linkage 24 at pivot locations 27a, 27b. Each linkage 24 is also pivotally coupled at a second end to a gear box 22 which, as is known in the art, is selectively driven by the power head 14 to impart high-frequency oscillatory movement to the vertical mounting arms 26a, 26b and the coupled blade assembly 32. For example, in some applications, the vertical mounting arms 26a, 26b and coupled blade assembly 32 may oscillate at a rate of, e.g., 20 strokes per second. The gear box 22 may be configured as a hydrostatic drive transmission or any other appropriate transmission.

While FIG. 1 illustrates the power head 14 as being an internal combustion engine, it is to be understood that other power head configurations, such as, e.g., one or more electric motors, may be utilized to drive the various components of the sod cutter 10. Additionally and/or alternatively, the blade assembly 32 described in this document may be used on other sod cutter configurations different from that which is shown in FIG. 1.

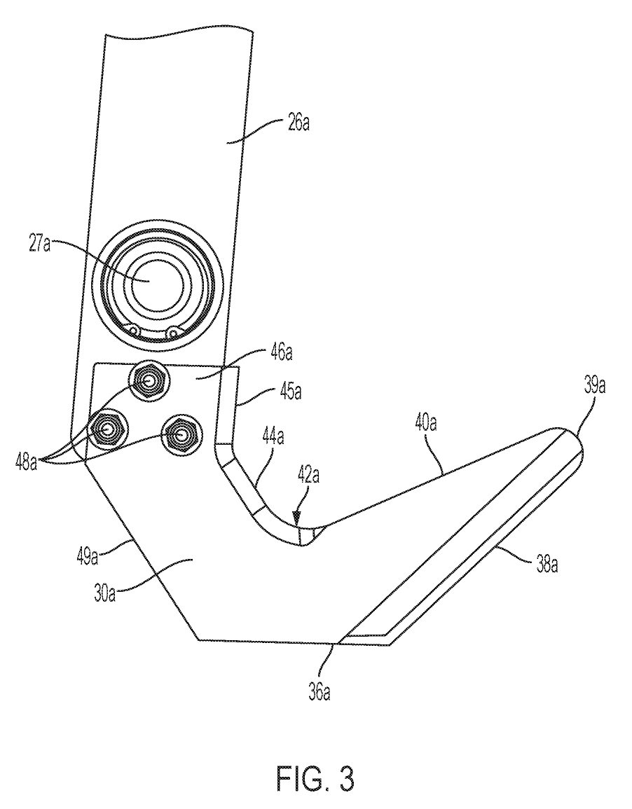

FIGS. 2-3 illustrate more detailed views of blade assembly 32 in accordance with an aspect of the disclosure. As described above with respect to FIG. 1, blade assembly 32 is configured to be removably coupled to respective vertical mounting arms 26a, 26b. More specifically, blade assembly 32 includes a pair of substantially U-shaped vertical knives 30a, 30b, each of which are coupled to a respective vertical mounting arm 26a, 26b via, e.g., respective fasteners 48a, 48b. In this way, blade assembly 32 can be easily removed for blade sharpening, repair, and/or replacement. Fasteners 48a, 48b may be any appropriate fastening means such as, e.g., bolts/nuts, screws, etc. As shown in FIGS. 2-3, fasteners 48a, 48b are arranged in a substantially triangular, three-hole pattern, which is a coupling standard used by many sod cutter manufacturers. Accordingly, blade assembly 32 is not necessarily limited to use with a single manufacturer's product. Furthermore, the size/width of blade assembly 32 could be changed and/or modified to accommodate different makes and/or models of sod cutters and/or different applications. Blade assembly 32 may be formed of any appropriate material or materials, such as, e.g., steel alloy, carbon steel, cast steel, stainless steel, hard plastics, etc.

As shown in FIG. 2, a horizontal blade 34 extends between the respective vertical knives 30a, 30b proximate to a base 36a, 36b of each knife 30a, 30b. The horizontal blade 34 may be attached to the vertical knives 30a, 30b via, e.g., welding, or vertical knives 30a, 30b and horizontal blade 34 may be unitarily formed via, e.g., bending, stamping, molding, etc.

As described above, during operation of the sod cutter, the blade assembly 32 is driven to oscillate at a high frequency, causing the vertical knives 30a, 30b to penetrate and cut the sod at a given width, while the horizontal blade 34 slices below the sod surface at a given depth, thereby creating a removable sod strip. A frontward-facing edge of the horizontal blade 34 may be sharpened or beveled so as to better slice through the soil and/or roots lying below the surface of the lawn. Additionally, the vertical knives 30a, 30b may each have respective sharpened or beveled front edges 38a, 38b, wherein each front edge 38a, 38b extends from a base 36a, 36b to a toe 39a, 39b of the respective vertical knife 30a, 30b. In this way, vertical knives 30a, 30b are able utilize the sharpened or beveled front edges 38a, 38b to better penetrate or cut the sod to a desired depth and at a desired width, thereby allowing the blade assembly 32 to more smoothly and cleanly cut a sod strip.

In addition to the sharpened or beveled front edges 38a, 38b, the vertical knives 30a, 30b also may include respective sharpened or beveled ancillary edges 44a, 44b. As shown in FIGS. 2-3, ancillary edges 44a, 44b may be sharpened or beveled from approximately a valley 42a, 42b of the U-shaped vertical knives 30a, 30b to the terminus of a mounting location 46a, 46b utilized for fastening of the vertical knives 30a, 30b to a respective vertical mounting arm 26a, 26b. Proximate to the mounting locations 46a, 46b, the ancillary edges 44a, 44b include edge portions 45a, 45b, wherein edge portions 45a, 45b extend slightly beyond a front edge of the vertical mounting arms 26a, 26b. With this configuration, ancillary edges 44a, 44b provide the respective vertical knives 30a, 30b with added ability to penetrate or cut the sod to a desired depth, width, and/or length, particularly when blade assembly 32 is used in thick grasses such as, e.g., St. Augustine grasses. As the edge portions 45a, 45b extend slightly beyond the front edge of vertical mounting arms 26a, 26b, the sharpened or beveled edge of each edge portion 45a, 45b is capable of being effectively used to cut the sod layer, thereby allowing the entire forward-facing portion of each vertical knife 30a, 30b to be utilized for cutting, if need be.

As noted above, blade assembly 32 may be particularly useful in cutting sod strips containing dense grasses such as, e.g., St. Augustine grasses. St. Augustine grasses known to be particularly difficult to slice and sever into individual sod strips, as St. Augustine grasses include stolons interwoven throughout the lawn surface. Stolons are essentially small, elongated vines or roots which extend above the ground surface between the nodes of individual grass shoots, thereby allowing the St. Augustine grasses to spread over a given area. However, during sod cutting operations, some of the stolons may avoid the cutting action of each front edge 38a, 38b of the respective vertical knives 30a, 30b, and may actually loop over the respective toes 39a, 39b. With a conventional blade assembly for a sod cutter, these looped stolons would potentially obstruct or bind movement of the blade assembly, as the only sharpened edge on the respective vertical knives is the front edge equivalent to front edges 38a, 38b. Such an obstruction or binding of the blade assembly may lead to the sod cutter being turned in an undesired direction, making the sod cutter difficult to control and potentially removing sod from an unintended location. However, in the blade assembly 32, sharpened or beveled ancillary edges 44a, 44b provide a cutting or severing means beyond front edges 38a, 38b and toes 39a, 39b. As such, in the event that stolons do loop over toes 39a, 39b of respective vertical knives 30a, 30b during operation, the ancillary edges 44a, 44b are configured to cut or sever the stolons, allowing the blade assembly 32 to pass smoothly and cleanly through the grass surface to provide a desired sod strip, and enabling the operator to better control the path of the sod cutter.

Referring still to FIGS. 2-3, vertical knives 30a, 30b also include respective top edges 40a, 40b, wherein top edges 40a, 40b extend approximately from the respective toes 39a, 39b to the respective valleys 42a, 42b. In some embodiments, top edges 40a, 40b are not sharpened or beveled, as the top edges 40a, 40b are not forward-facing and do not generally come into contact with the sod layer to be cut by blade assembly 32. Additionally, by not sharpening or beveling top edges 40a, 40b, the structural integrity of vertical knives 30a, 30b may be better maintained, as less material is removed. Similarly, vertical knives 30a, 30b also include respective heel edges 49a, 49b, which are also typically not sharpened or beveled. However, it is to be understood that, in some embodiments, top edges 40a, 40b and/or heel edges 49a, 49b may be sharpened or beveled.

Turning again to FIG. 3, the features of vertical knife 30a will be described in greater detail. When utilized in conjunction with the other features of blade assembly 32, vertical knife 30a operates as one side of a pair of sides of the blade assembly 32, acting as both a limit to the width of the sod strip and as a tool for penetrating the ground surface as the sod cutter progresses forward. When mounted on a sod cutter, the toe 39a represents the forward-most projecting point of the “side” 30a, with a pair of respective edges extending rearwardly from the toe 39a. The first edge, described above as front edge 38a, extends angularly in a downward and rearward direction from toe 39a to base 36a. This first edge may be beveled or sharpened, as it represents the primary cutting surface of the vertical knife (or “side”) 30a. A second edge also extends in a rearward direction from toe 39a, but the second edge may be formed of the combined surfaces of the top edge 40a, the valley 42a, and the ancillary edge 44a.

Unlike previous vertical knives (or “sides”) used in sod cutter blade assemblies, all or some of surfaces making up this second edge of vertical knife 30a may be beveled or sharpened so as to provide for additional cutting capabilities. For example, as shown in FIG. 3, the second edge may have a beveled or sharpened portion extending from a valley 42a to the uppermost terminus of the second edge, extending entirely along the height of the mounting location 46a. In this way, the second edge may have a beveled or sharpened edge portion which extends angularly in an upward and rearward direction (as is illustrated by ancillary edge 44a) and/or a beveled or sharpened edge which extends vertically. Alternatively, while not shown in FIG. 3, the second edge may be beveled or sharpened along all portions, including top edge 40a. Accordingly, the “side”, or vertical knife, 30a is provided with two edges extending rearwardly from a forward-most point, with both edges being beveled or sharpened along at least a portion thereof.

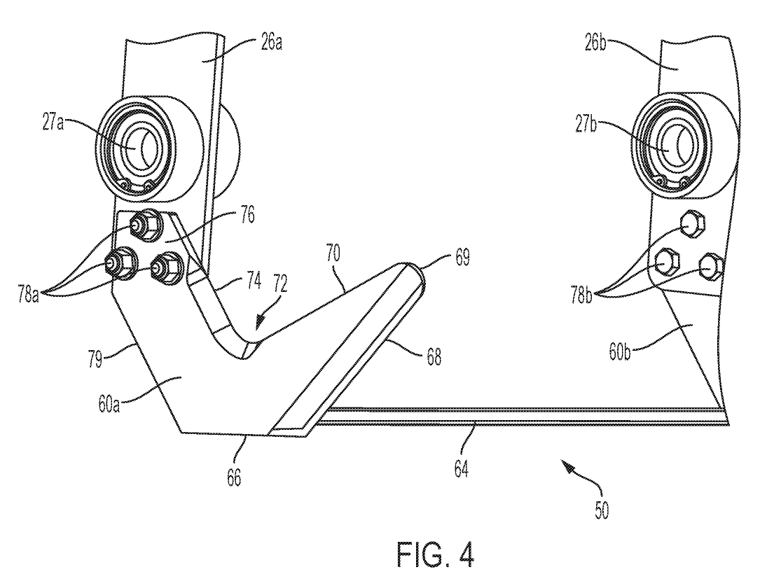

Next, referring to FIG. 4, a blade assembly 50 in accordance with another aspect of the disclosure is shown. Similar to blade assembly 32 described above with respect to FIGS. 1-3, blade assembly 50 is configured to be removably coupled to respective vertical mounting arms 26a, 26b. Blade assembly 50 includes a pair of vertical knives 60a, 60b, each of which are coupled to a respective vertical mounting arm 26a, 26b via, e.g., respective fasteners 78a, 78b so as to allow for easy removal and/or replacement. Blade assembly 50 may be formed of any appropriate material or materials, such as, e.g., steel alloy, carbon steel, cast steel, stainless steel, hard plastics, etc. Furthermore, while all features of vertical knife 60b are not shown in FIG. 4, it is to be understood that vertical knives 60a, 60b are substantially identical.

A horizontal blade 64 extends between the respective vertical knives 60a, 60b proximate to a base 66 of each knife 60a, 60b. The horizontal blade 64 may be attached to the vertical knives 60a, 60b via, e.g., welding, or vertical knives 60a, 60b and horizontal blade 64 may be unitarily formed via, e.g., bending, stamping, molding, etc.

As described above, during operation of the sod cutter, the blade assembly 50 is driven to oscillate at a high frequency, causing the vertical knives 60a, 60b to penetrate and cut the sod at a given width, while the horizontal blade 64 slices below the sod surface at a given depth, thereby creating a removable sod strip. A frontward-facing edge of the horizontal blade 64 may be sharpened or beveled so as to better slice through the soil and/or roots lying below the surface of the lawn. Additionally, the vertical knives 60a, 60b may each have respective sharpened or beveled front edges 68, wherein each front edge 68 extends from a base 66 to a toe 69 of the respective vertical knife 60a, 60b. In this way, vertical knives 60a, 60b are able utilize the sharpened or beveled front edges 68 to better penetrate or cut the sod to a desired depth and at a desired width, thereby allowing the blade assembly 50 to more smoothly and cleanly cut a sod strip.

In addition to the sharpened or beveled front edges 68, the vertical knives 60a, 60b also may include respective sharpened or beveled ancillary edges 74. As shown in FIG. 4, ancillary edges 74 may be sharpened or beveled from approximately a valley 72 to the beginning of a mounting location 76 utilized for fastening of the vertical knives 60a, 60b to a respective vertical mounting arm 26a, 26b. That is, unlike ancillary edges 44a, 44b described above with respect to FIGS. 2-3, ancillary edges 74 do not include sharpened or beveled edge portions extending to the terminus of the mounting area 76, but rather include sharpened or beveled edge portions extending approximately to a location where the ancillary edge 74 meets a front edge of a respective mounting arm 26a, 26b. With this configuration, ancillary edges 74 provide the respective vertical knives 60a, 60b with added ability to penetrate or cut the sod to a desired depth, width, and/or length, particularly when blade assembly 50 is used in thick grasses such as, e.g., St. Augustine grasses.

Referring still to FIG. 4, vertical knives 60a, 60b also include respective top edges 70, wherein top edges 70 extend approximately from the respective toes 69 to the respective valleys 72. In some embodiments, top edges 70 are not sharpened or beveled, as the top edges 70 are not forward-facing and do not generally come into contact with the sod layer to be cut by blade assembly 50. Additionally, by not sharpening or beveling top edges 70, the structural integrity of vertical knives 60a, 60b may be better maintained, as less material is removed. Similarly, vertical knives 60a, 60b also include respective heel edges 79, which are also typically not sharpened or beveled. However, it is to be understood that, in some embodiments, top edges 70 and/or heel edges 79 may also be sharpened or beveled.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A blade assembly for use with a sod cutter, the blade assembly comprising:
a first vertical knife;
a second vertical knife; and
a horizontal blade extending between and coupled to an interior surface of both the first vertical knife and the second vertical knife,
wherein each of the first vertical knife and the second vertical knife comprises a first beveled edge extending along a first frontward-facing edge from a toe portion to a base portion of each of the first vertical knife and the second vertical knife, and
further wherein each of the first vertical knife and the second vertical knife comprises a second beveled edge extending along a second frontward-facing edge proximate to a mounting portion of each of the first vertical knife and the second vertical knife.

2. The blade assembly of claim 1, wherein each of the first vertical knife and the second vertical knife are U-shaped, and the second frontward-facing edge extends from a valley formed in each of the first vertical knife and the second vertical knife to a terminus of the mounting portion of each of the first vertical knife and the second vertical knife.

3. The blade assembly of claim 2, wherein the mounting portion of each of the first vertical knife and the second vertical knife is configured to be coupled to a respective vertical mounting arm of the sod cutter.

4. The blade assembly of claim 3, wherein the second frontward-facing edge of each of the first vertical knife and the second vertical knife extends at least partially forward of a front edge of each of the respective vertical mounting arms of the sod cutter.

5. The blade assembly of claim 2, wherein the mounting portion of each of the first vertical knife and the second vertical knife comprises a triangular, three-hole pattern for removably coupling each of the first vertical knife and the second vertical knife to a respective vertical mounting arm of the sod cutter.

6. The blade assembly of claim 1, wherein each of the first forward-facing edge and the second forward-facing edge comprise sharpened edges.

7. The blade assembly of claim 1, wherein the first vertical knife, the second vertical knife, and the horizontal blade are each formed of one or more of a steel alloy, a carbon steel, a cast steel, a stainless steel, and a hard plastic.

8. A sod cutter comprising:
a frame;
a power head coupled to the frame;
at least one drive wheel operably coupled to the power head;
a gear box coupled to the frame and operably coupled to the power head, wherein the gear box is configured to convey high-frequency oscillatory motion on a first vertical mounting arm on a first lateral side of the frame and a second vertical mounting arm on a second lateral side of the frame opposite the first lateral side; and
a blade assembly, the blade assembly comprising:
a first vertical knife coupled to the first vertical mounting arm;
a second vertical knife coupled to the second vertical mounting arm; and
a horizontal blade extending between and coupled to an interior surface of both the first vertical knife and the second vertical knife,
wherein each of the first vertical knife and the second vertical knife comprises a first beveled edge extending along a first frontward-facing edge from a toe portion to a base portion of each of the first vertical knife and the second vertical knife, and
further wherein each of the first vertical knife and the second vertical knife comprises a second beveled edge extending along a second frontward-facing edge proximate to a mounting portion of each of the first vertical knife and the second vertical knife.

9. The sod cutter of claim 8, further comprising a blade depth adjustment mechanism operably coupled to the first vertical mounting arm and the second vertical mounting arm.

10. The sod cutter of claim 8, wherein each of the first vertical knife and the second vertical knife are U-shaped, and the second frontward-facing edge extends from a valley formed in each of the first vertical knife and the second vertical knife to a terminus of the mounting portion of each of the first vertical knife and the second vertical knife.

11. The sod cutter of claim 8, wherein the second frontward-facing edge of each of the first vertical knife and the second vertical knife extends at least partially forward of a front edge of the respective first vertical mounting arm and the second vertical mounting arm.

12. The sod cutter of claim 8, wherein the mounting portion of each of the first vertical knife and the second vertical knife comprises a triangular, three-hole pattern for removably coupling each of the first vertical knife and the second vertical knife to the respective first vertical mounting arm and the second vertical mounting arm.

13. The sod cutter of claim 8, wherein each of the first forward-facing edge and the second forward-facing edge comprise sharpened edges.

14. A blade assembly for use with a sod cutter, the blade assembly comprising:
a first side; and
a second side,
wherein each of the first side and the second side comprises a forward-most projecting point extending therefrom, a first edge extending rearwardly from forward-most projecting point, and a second edge extending rearwardly from the forward-most projecting point,
and further wherein at least a portion of both the first edge and the second edge of the first side comprises a beveled surface.

15. The blade assembly of claim 14, wherein the first edge extends at a rearward and downward angle from the forward-most projecting point to a base of each of the first and second sides.

16. The blade assembly of claim 15, wherein an entire length of the first edge comprises a beveled surface.

17. The blade assembly of claim 14, wherein the second edge comprises a top edge portion, a valley portion, and an upwardly-extending portion.

18. The blade assembly of claim 17, wherein the top edge portion extends at a rearward and downward angle from the forward-most projecting point to the valley portion.

19. The blade assembly of claim 17, wherein the valley portion and the upwardly-extending portion of the second edge comprise a beveled surface.

20. The blade assembly of claim 19, wherein the upwardly-extending portion extends to a terminus of a mounting location of each of the first and second sides configured for mounting of the first and second sides to a respective mounting arm of the sod cutter.

21. The blade assembly of claim 14, further comprising a blade extending between and coupled between the first and second sides.
